(19) United States
(12) Patent Application Publication
(10) Pub. No.: US 2018/0053192 A1
(43) Pub. Date: Feb. 22, 2018

(54) SYSTEM AND METHOD FOR ENGAGING CUSTOMERS THROUGH CONTINUOUS FEEDBACK LOOPS

(71) Applicant: APKIRAI TECHNOLOGIES PVT LTD., Hyderabad (IN)

(72) Inventors: NARAYANA AROORI, Hyderabad (IN); DEEPAK MOHAN, Hyderabad (IN); SMITI MOHAN, Hyderabad (IN)

(21) Appl. No.: 15/681,348

(22) Filed: Aug. 19, 2017

(30) Foreign Application Priority Data
Aug. 20, 2016 (IN) 201641021042

(51) Int. Cl. G06Q 30/00; H04L 12/58

(52) U.S. Cl. CPC G06Q 30/01; H04L 51/04

(57) ABSTRACT

The embodiments herein provide a system and method for engaging a plurality of customers to a plurality of businesses using a single platform. The system includes a plurality of computing devices, an application server, a plurality of business units, and a communication network. The customer initiates the request utilizing an application on the computing device to connect to the application server. The application server receives the engagement request from the computing device and routes the request to the concerned businesses. The engagement is initiated using a plurality of ways, including but not limited to scanning or sensing technologies and the like. The system creates an exclusive bi-directional communication between businesses and customers for feedback, assistance and complete surveys instantly while the customers are using goods and services from the businesses. The system provides a unified incentive program to the customers to interact with the businesses.

### CROSS-REFERENCE TO RELATED APPLICATION

The embodiments herein claims the priority of the Indian Provisional patent application with the serial number 201641021042 filed on Jun. 20, 2016 and subsequently Post-dated by 2 month to Aug. 20, 2016 with the title, “A SYSTEM AND METHOD FOR ENGAGING CUSTOMERS THROUGH CONTINUOUS FEEDBACK LOOPS”, and the contents of which is included entirely as reference herein.

### BACKGROUND

### Technical Field

The embodiments herein are generally related to the field of customer engagement. The embodiments herein are particularly related to customer engagement through a dedicated platform. The embodiments herein are more particularly related to customer engagement platform utilizing continuous feedback loops

### Description of the Related Art

Customer engagement is defined as an effect, a reaction, a connection, a response and an experience of the customer with a business unit. The customers are engaged in various ways through a variety of medium. Building profitable customer relationships is a complex business process that requires a multi-disciplinary and holistic customer engagement approach. Further, due to the heavy penetration of internet and social media with the entire product and service lifecycle, it is essential to engage with the customers effectively to retain loyalty and avoid unnecessary complaints, which may harm the businesses.

Existing customer engagement platforms are designed to engage the customers using traditional methods, including but not limited to single competency approach, customer relationship management (CRM), a dedicated mobile application, a feedback system, social media and the like. However, these methods have often failed as the customer has to initiate the process multiple times, and also most of the businesses or business entities do not respond on time. Further, businesses or the business entities share the surveys after the customer interaction leading to delays, lower response rates and inability to resolve a customer issue in time.

Further, the businesses or the business entities also face a problem by not receiving the complaints/feedback dynamically or in near real-time due to multiple routings. Customers may post negative comments about the businesses or the business entities on social media like twitter. This may affect the brand value of the businesses, or the business entities even though the businesses or the business entities are willing to actively engage the customers.

Hence, there is a need for a system and method for engaging customers dynamically and in (near) real-time. Further, there is a need for a system and method for using a single platform to engage a plurality of customers with a plurality of business or the business entities using a continuous feedback loop.

The above-mentioned shortcomings, disadvantages, and problems are addressed herein and which will be understood by reading and studying the following specification.

### OBJECTS OF THE EMBODIMENTS HEREIN

The primary object of the embodiments herein is to engage a plurality of customers through a single platform.

Another object of the embodiments herein is to engage a plurality of customers and a plurality of businesses or the business entities through a dedicated cloud platform.

Yet another object of the embodiments herein is to allow a customer to initiate the interaction with a business or the business entity, when required, in (near) real-time.

Yet another object of the embodiments herein is to provide a timely in-context customer service and surveys.

Yet another object of the embodiments herein is to detect a mode of customer engagement and channelize to concerned businesses or the business entities accordingly.

These and other objects and advantages of the embodiments herein will become readily apparent from the following detailed description taken in conjunction with the accompanying drawings.

### SUMMARY

The embodiments herein provide a method of engaging customers with a plurality of business units or entities in near real time. The method includes engaging customers with business units or entities over a customer engagement platform. The embodiments discloses a method of routing the requests of the customer to concerned business units or the business entities and actively engaging each customers with concerned business units or the business entities by sending the messages over a continuous feedback loop link.

According to an embodiment herein, a computer-implemented method for engaging a plurality of customer with a plurality of business units in near-real time using a customer engagement platform is disclosed. The method includes creating accounts for the plurality of business units with the customer engagement platform built on an application server for actively engaging with the plurality of customers. The method further includes creating a plurality of business objects using the customer engagement platform for conducting a survey and receiving feedback from the plurality of customers. The images and specification of the plurality of business objects created is uploaded to the application server. Further, the method includes registering the plurality of customers with the customer engagement platform for engaging with the plurality of business units. Each customer is registered by providing a plurality of details through a computing device. Furthermore, the method includes storing a plurality of data in a database in the application server. The plurality of data includes but not limited to plurality of details of the customers, the account details of the plurality of business units, the business objects created, metadata of the application server and the like.

The method further includes identifying business objects using the computing device when the customer enters a business unit premises in a plurality of modes. The details of the business objects identified is transmitted to the application server. Further, the method includes processing the details of the business objects identified for routing the requests of the customer to the concerned business units. Furthermore, the method includes establishing a continuous feedback loop (CFL) link between the concerned business units and the customer for providing active near real time engagement. The customers are engaged by responding to queries and service request raised by the customers. Further, the method includes billing services availed by the customer from the concerned business units.

According to an embodiment herein, the method of engaging a plurality of customer with a plurality of business units in near-real time is performed by sending a plurality of messages through the CFL link established already.

According to an embodiment herein, the method further includes initiating a survey with the customer based on the business objects identified by the computing device.

According to an embodiment herein, the plurality of modes for identifying the business objects when the customer enter the premises is disclosed. A first mode includes capturing a plurality of images of a first business object using a camera in the computing device. The plurality of images are processed by the application server for identifying the first business object. A second mode includes scanning a linear code on a second business object using a code reader in the computing device. The linear code is decoded by one of the computing device and application server to identify the second business object. A third mode includes sensing presence of a third business object using a plurality of sensors in the computational device. The data sensed is analyzed by the application server to identify the third business object. A fourth mode includes tracking location coordinates of a fourth business object along with event criteria including exit, entry and residence time or stay period. The location coordinates are transmitted to the application server to identify the fourth business object.

According to an embodiment herein, the plurality of details provided for registering with the application server includes but not limited to name, e-mail id, contact details, phone number, location, and the like.

According to an embodiment herein, the plurality of business objects created includes but not limited to physical objects, locations, stakeholders, services, and the like.

According to an embodiment herein, the plurality of business objects uploaded to the application server is dynamically updated and refreshed periodically.

According to an embodiment herein, the plurality of sensors for sensing the business objects includes but not limited to Bluetooth, beacon, near field communicators, radiofrequency (RF) transmitters, geo-location services, and the like.

According to an embodiment herein, the CFL link is established through the application server when the customer requires assistance or raises a service request.

According to an embodiment herein, the method further includes billing the subscription services availed by plurality of business units.

According to an embodiment herein, a step of engaging the plurality of customers with the plurality of business units in near-real time is achieved by programs which include but not limited to surveys, enterprise feedback management, experience sharing, customer feedback, customer satisfaction, net promoter score, top box scores, voice of the customer, customer experience, instantaneous feedback, actionable feedback, customer service, help desk, instantaneous response and the like.

According to an embodiment herein, the method further comprises providing reward points to the plurality of customers based on engagement activities of each customer with a plurality of business units.

According to an embodiment herein, the customer or user is selected from a group consisting of a consumer, patient, buyer, and viewer, etc.

According to an embodiment herein, the business unit or business entity is selected from a group consisting of a hospital, business establishment or organization, hotel, mail, stadium, theater, health care provider or hospitality industry etc.

According to an embodiment herein, a method of engaging a plurality of customers with a plurality of business units through an application server is disclosed. The method includes creating accounts for the plurality of business units with a customer engagement platform built on the application server for actively engaging with the plurality of customers. The method further includes creating a plurality of business objects using the customer engagement platform for receiving feedback from the plurality of customers. Initially, the plurality of business objects are identified for receiving a feedback of the plurality of business units from the plurality of customers. The examples of the plurality of business entities includes but are not limited to physical objects (e.g. laptops, vehicles, consumer goods), locations (e.g. restaurants, theatres, emergency room, stadiums, parks), stakeholders (e.g. teachers, lawyers, doctors, consultants), services (customer support, installations, repairs, sales), and the like.

The plurality of business objects are classified as scan code objects, sense objects and geofence objects. The scan code objects are business objects comprising a scanning interface. The scanning interface includes a one dimensional linear bar codes encoded on the scan code objects such as QR codes, UPC codes, boarding passes and the like. Further, the sense objects are business objects comprising a transmitter unit. The examples of the transmitter unit include a bluetooth, a beacon, near field communicators, RF transmitters, geo-location services, location based services and the like. A transmitter unit on a sense object transmits a unique code for identification. Furthermore, the geofence is a perimeter definition of a geographic area along with event criteria like entry/exit/dwelling period.

Once the plurality of business objects are created, the images and specification for each business object is uploaded into the application server. Further, the customer engagement platform creates a continuous feedback loop (CFL) port for each business object. The plurality of business units are further enabled to distribute the CFL ports by publishing codes or installing a transmitter at the business unit. Thus, the plurality of business units are ready to engage with the plurality of customers.

Further, the method includes registering the plurality of customers with the customer engagement platform for engaging with the plurality of business units. On registering with the customer engagement platform, the customer is enabled to download a customer engaging application from the application server. The customer engaging application is downloaded and installed on a computing device of the customer. Further, the customer engaging application on the computing device identifies the plurality of business objects when a customer enter a premises.

For example consider a laptop is kept in the premises. The customer is enabled to encounter and scan the linear bar code encoded on the laptop using a code reader on the computing device. When the customer enters the range of a sense object, a transmitter unit on the sense object prompts the customer to initiate a communication. For example, consider that the location of Taj Hotel is a sense object. When the customer enters the lobby of the Taj hotel, a beacon in the Taj hotel lobby transmits a unique code to the customer engaging application, to prompt the customer to engage with the services in the Taj hotel. In case of geofence objects, the application server tracks the customer engaging application on the computing device to identify the customer who has entered/exited/dwelled in the range of a defined geofence object. Once a geofence object, say a hospital is identified, the customer engaging application in the computing device is triggered to identify any other scan object or sense object in the region to identify the floor to which the customer has entered. Further, the customer engaging application prompts the customer to engage in communication with the concerned business unit.

The customer engaging application on the computing device further connects with the application server to identify the business object. The business object identified by the computing device is processed on the computing unit or the application server. Once the business object is identified, the customer engagement platform routes the communication to the concerned business unit. Based on the business object identified, the customer engaging application establishes a CFL link with the server through a CFL port of the business object. The CFL link is established by the customer engaging application with the respective business units. Further the customer is enabled to decide on the type of interaction. The type of interaction includes but not limited to instant feedback, getting assistance, surveys and the like. After the interaction, the CFL link is terminated based on a decision of the customer or the business unit.

The scan code objects are encoded using any one of a public symbology specifications (QR code, GSI UPC, IATA BCBP) and a propriety symbology specification. For example, a physical objects such as a laptop is encoded with a linear bar code outer casing for identification. The scan code objects created by the plurality of business units are of three different types. The first type of scan code object is a private scan code object created and managed by each business unit. While creating a first type of scan code object, each business unit integrates a decoding module with the customer engagement platform.

Each business unit is enabled to create any number of geofence objects. The application server tracks each consumer app in real time to detect whether a consumer has entered or exited or dwelled in a defined geofence object. Then it can trigger an event on the consumer mobile app, indicating the user has entered or exited a business area—for which he/she may be interested in interacting. The app can prompt the customer to engage with the particular business's customer service or survey as required

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will be apparent to those skilled in the art from the following description of the preferred embodiment and the accompanying drawings in which:

FIG. 1 illustrates a block diagram of a system for engaging a plurality of customers and a plurality of business units or the business entities through a customer engagement platform, according to one embodiment herein.

FIG. 2 illustrates a functional block diagram of user or consumer computing device and web server in a system for engaging a plurality of customers and a plurality of business units or the business entities through a customer engagement platform, according to one embodiment herein.

FIG. 3 illustrates a flowchart explaining a method of business engagement with a plurality of customers, according to one embodiment herein.

FIG. 4 illustrates a flowchart explaining a method of customer engagement with a plurality of business units, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein provide a method of engaging customers with a plurality of business units or entities in near real time. The method includes engaging customers with business units or entities over a customer engagement platform. The embodiments discloses a method of routing the requests of the customer to concerned business units or the business entities and actively engaging each customers with concerned business units or the business entities by sending the messages over a continuous feedback loop link.

According to an embodiment herein, a computer-implemented method for engaging a plurality of customer with a plurality of business units in near-real time using a customer engagement platform is disclosed. The method includes creating accounts for the plurality of business units with the customer engagement platform built on an application server for actively engaging with the plurality of customers. The method further includes creating a plurality of business objects using the customer engagement platform for conducting a survey and receiving feedback from the plurality of customers. The images and specification of the plurality of business objects created is uploaded to the application server. Further, the method includes registering the plurality of customers with the customer engagement platform for engaging with the plurality of business units. Each customer is registered by providing a plurality of details through a computing device. Furthermore, the method includes storing a plurality of data in a database in the application server. The plurality of data includes but not limited to plurality of details of the customers, the account details of the plurality of business units, the business objects created, metadata of the application server and the like.

The method further includes identifying business objects using the computing device when the customer enters a business unit premises in a plurality of modes. The details of the business objects identified is transmitted to the application server. Further, the method includes processing the details of the business objects identified for routing the requests of the customer to the concerned business units. Furthermore, the method includes establishing a continuous feedback loop (CFL) link between the concerned business units and the customer for providing active near real time engagement. The customers are engaged by responding to queries and service request raised by the customers. Further, the method includes billing services availed by the customer from the concerned business units.

According to an embodiment herein, the method of engaging a plurality of customer with a plurality of business units in near-real time is performed by sending a plurality of messages through the CFL link established already.

According to an embodiment herein, the method further includes initiating a survey with the customer based on the business objects identified by the computing device.

According to an embodiment herein, the plurality of modes for identifying the business objects when the customer enter the premises is disclosed. A first mode includes capturing a plurality of images of a first business object using a camera in the computing device. The plurality of images are processed by the application server for identifying the first business object. A second mode includes scanning a linear code on a second business object using a code reader in the computing device. The linear code is decoded by one of the computing device and application server to identify the second business object. A third mode includes sensing presence of a third business object using a plurality of sensors in the computational device. The data sensed is analyzed by the application server to identify the third business object. A fourth mode includes tracking location coordinates of a fourth business object along with event criteria including exit, entry and residence time or stay period. The location coordinates are transmitted to the application server to identify the fourth business object.

According to an embodiment herein, the plurality of details provided for registering with the application server includes but not limited to name, e-mail id, contact details, phone number, location, and the like.

According to an embodiment herein, the plurality of business objects created includes but not limited to physical objects, locations, stakeholders, services, and the like.

According to an embodiment herein, the plurality of business objects uploaded to the application server is dynamically updated and refreshed periodically.

According to an embodiment herein, the plurality of sensors for sensing the business objects includes but not limited to Bluetooth, beacon, near field communicators, radiofrequency (RF) transmitters, geo-location services, and the like.

According to an embodiment herein, the CFL link is established through the application server when the customer requires assistance or raises a service request.

According to an embodiment herein, the method further includes billing the subscription services availed by plurality of business units.

According to an embodiment herein, a step of engaging the plurality of customers with the plurality of business units in near-real time is achieved by programs which include but not limited to surveys, enterprise feedback management, experience sharing, customer feedback, customer satisfaction, net promoter score, top box scores, voice of the customer, customer experience, instantaneous feedback, actionable feedback, customer service, help desk, instantaneous response and the like.

According to an embodiment herein, the method further comprises providing reward points to the plurality of customers based on engagement activities of each customer with a plurality of business units.

According to an embodiment herein, the customer or user is selected from a group consisting of a consumer, patient, employee, buyer, and viewer, etc.

According to an embodiment herein, the business unit or business entity is selected from a group consisting of a hospital, business establishment or organization, hotel, mall, stadium, theater, health care provider, employer, and hospitality industry etc.

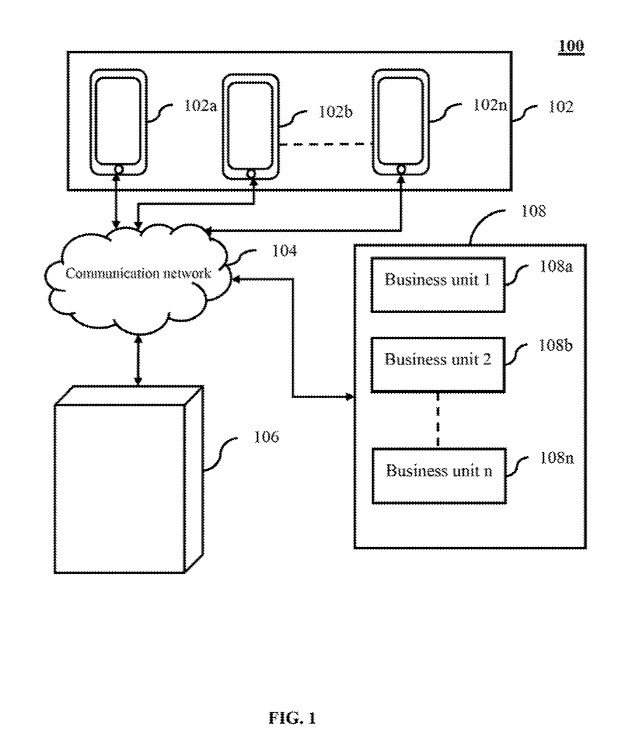

FIG. 1 illustrates a block diagram of a system for engaging a plurality of customers and a plurality of business units through a customer engagement platform, according to one embodiment herein. The system diagram 100 includes a plurality of computing devices 102a, 102b, . . . 102n, which is collectively represented as user computing devices 102, a communication network 104, an application server 106, and a plurality of business units 108a, 108b, . . . 108n, which is collectively represented as business groups 108.

The computing devices 102, the application server 106, and the business groups 108 communicate with each other through the communication network 104 for engaging a plurality of customers with the business groups 108. The examples of the communication network 104 include, but are not limited to a telecommunication network, the internet, intranet, a radio frequency network (RF), a wide area network (WAN), a local area network (LAN), and the like.

The computing devices 102 are the electronic devices that are capable of communicating with other devices utilizing the communication network 104. The examples of the computing devices 102 include, but are not limited to a smartphone, a laptop, a wearable device, a smart television, a desktop, a tablet computer, a virtual reality device, and the like. The computing devices 102 accesses the application server 106 through different means. According to an embodiment herein, the computing devices 102 accesses the application server 106 by downloading an application from an application store. The other means of accessing the application server 106 include, but are not limited to a website, a native software, and the like.

Typically, the application server 106 is configured to collect information about the plurality of customers through the computing devices 102 and routes the query/service to concerned business units. The application server 106 includes a plurality of modules and a business logic to route the information to the concerned business units among the business groups 108.

The server units of the business groups 108 or the business units or business entities are configured to engage with the plurality of customers through the application server 106. The server units of the business groups 108 are configured to engage with the computing devices of the plurality of customers in a plurality of ways. The examples of the plurality of ways in which the business groups 108 engages with the plurality of customers include, but are not limited to surveys (online, offline, omnichannel), enterprise feedback management, experience sharing, customer feedback, customer satisfaction, net promoter score, top box scores, voice of the customer, customer experience, instantaneous feedback, actionable feedback, customer service, help desk, instantaneous response and the like.

According to an embodiment herein, the plurality of customers engage with the one or more business units among the business groups 108 through the user computing devices 102 and a customer engagement platform on the application server 106. The term “plurality of customers” used herein indicate people availing services from a business unit. The examples of plurality of customers includes but are not limited to consumers, patients, employees and the like. The term “business groups” used herein indicates people providing services or goods to others. The examples of business groups include but are not limited to business units or entities, healthcare providers, employers and the like.

For example, the servers of the business units or entities are configured to engage with the consumers through the user computing devices and the customer engagement platform by providing prompt services, answers to the queries of the consumers etc., thereby keeping the consumers happy, retaining the consumers and improving profitability. Similarly, the healthcare providers are enabled to engage the patients through the computing devices and the customer engagement platform, thereby providing proper patient care, good experiences, thereby keeping the patients healthier and reducing time and cost etc. Further, the employers are enabled to keep the employees engaged using the customer engagement platform, thereby resolving conflicts, developing a happier and healthier workforce, improving employee engagement and business results.

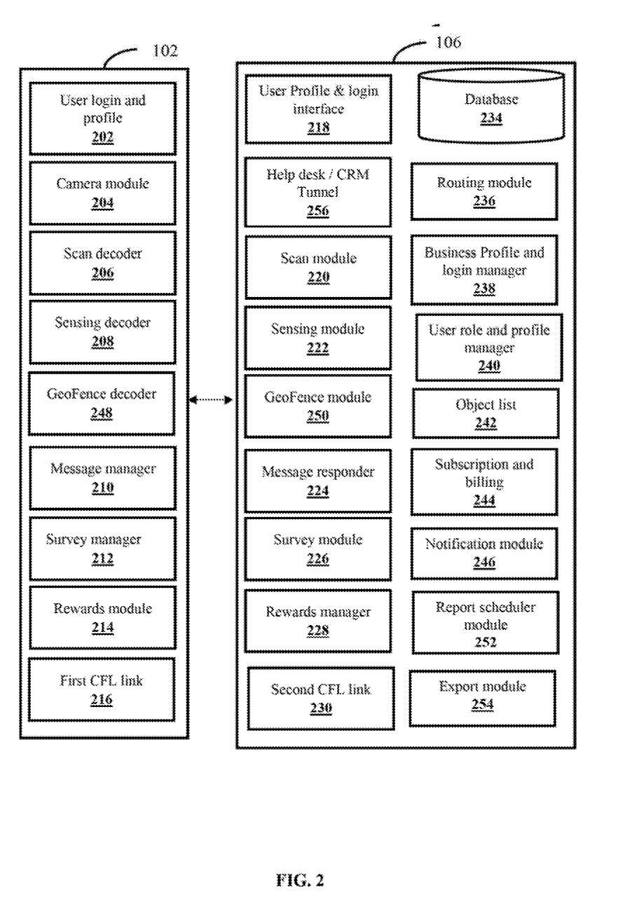

FIG. 2 illustrates a functional block diagram of the user computing device loaded with a customer application, and a server of the service provider customer engagement platform, according to one embodiment herein. The customer application is downloaded from the application server 106 and is installed in the computing device 102 of the customer. The customer engagement platform is provided by the application server 106. The users of the computing devices 102 engage with the one or more business units among the business groups through the application server 106.

The business groups initially creates an account with the application server 106. Further, each business unit among the business groups create a plurality of business objects using the customer engagement platform for receiving feedback from the plurality of customers. The images and specification of each business object created is uploaded to the application server 106. For example, each business objects is provided with a unique identifier. The examples of unique identifier includes but is not limited to a QR code, bar code, RFID tag and the like. According to an embodiment herein, the term “business objects” refers to one or more attributes for which the business units engage with the plurality of customers. The examples of the plurality of business objects include, but are not limited to physical objects (e.g. laptops, vehicles, consumer goods), locations (e.g. restaurants, theatres, parks), stakeholders (e.g. teachers, lawyers, doctors, consultants), services (customer support, installations, repairs, sales), and the like.

According to an embodiment herein, both the computing device 102 and the application server 106 includes a plurality of modules to enable an efficient customer engagement with the business groups. The modules at the computing device 102 are configured to collect the data regarding the business objects, perform preliminary analysis, and transmit the same to the modules present at the application server 106 for further processing and routing for the business groups.

The modules present at the computing device 102 include a customer login and profile module 202, a camera module 204, a scan decoder 206, a sensing decoder 208, a geofence decoder 248, a message manager 210, a survey module 212, a rewards module 214, and a first CFL link 216. The modules present at the application server 106 include a user interface 218, a scan module 220, a sensing module 222, a geofence module 250 a message responder 224, a survey module 226, a rewards manager 228, a second CFL link 230, a database 234, a routing module 236, a profile and login manager 238, a user role and profile manager 240, an object list 242, a subscription and billing module 244, a notification module 246, a report scheduler module 252, an export module 254, and a helpdesk and CRM tunnel module 256.

The customer login and profile module 202 is configured to register the customer with the application server 106 for efficient engagement with the plurality of businesses. The customer is enabled to register with the customer facing application by providing a plurality of details. The plurality of details provided by the customer includes, but not limited to name, e-mail id, contact details, phone number, location, and the like.

The camera module 204 is configured to enable the customers to capture a plurality of images. The camera module 204 stores and transmits the captured images to the application server 106. The captured image includes one of the business objects through which the customers and businesses engage with each other. The camera module is configured to be coupled with a camera in a mobile computing device, or any other portable image capturing device with a communication and transfer facility.

The scan decoder 206 is configured to scan a linear code on the business objects using a code reader. The examples of linear codes includes but are not limited to Quick Response (QR) code, bar code, Universal Product Code (UPC), airline boarding pass. The linear code provided on each business object is a unique identifier. According to an embodiment of the present invention, the scan decoder 206 is configured to capture the linear codes, decode the captured code data, and transmits the decoded code data to the application server 106.

The sensing decoder 208 is configured to detect a presence of the business objects through a plurality of sensors available on the computing device 102. According to an embodiment of the present invention, the sensing module 208 is configured to detect the business objects using the plurality of sensors such as a bluetooth, a beacon, near field communicators, RF transmitters, geo-location services, location based services and the like. The plurality of sensors are configured to identify the presence of the business object by sensing data including a unique identifier. The captured data is transmitted to the application server 106 for further processing.

The geofence decoder 248 is configured to track business objects such as a location defined by location coordinates along with event criteria including entry/exit/dwelling period. The location coordinates along with event criteria including entry/exit/dwelling period of each business objects is a unique identifier. The geofence module 248 tracks the location coordinates in real time to identify an entry, exit and presence of the customer with the computing device 102 into an area or building or premises marked or specified or located with longitudes and latitudes set by the service provider or business entity. The location coordinates of the business object tracked are communicated to the application server 106.

The message manager 210 is configured to communicate a plurality of messages from the business groups or units or entities that actively engage the customer. When the concerned business units or business entities are identified based on the business objects, the business unit or business entity is enabled to collect the plurality of details of the customer from the application server 106 through a server or computing device. The plurality of details collected from the customer includes but not limited to name, e-mail id, contact details, phone number, location, and the like. The message manager 210 is configured to send messages to the application server 106, when the customer requires some assistance or raises a service request. Further, the business groups is enabled to transmit the answers to the queries, the status of the request, and other information through the message manager 210.

The survey manager 212 is configured to send and receive a plurality of surveys to the customers. The survey module 212 is configured to communicate the surveys based on the location tracked by the geofence decoder 248, or when the computing device 102 senses a relevant business object. According to an embodiment herein, the survey manager 212 is configured to share the survey with the customer regarding the feedback of the customer experience and location, when the location is tracked. According to an embodiment herein, the survey manager 212 is configured to share one or more surveys from a plurality of businesses to the customers and transmit back the responses received from the customers to the respective business units. The plurality of surveys performed includes but not limited to single choice question, multiple choice question, rating question, free text question, ranking question, Boolean question, net promoter score question and the like. Further, the rewards module 214 is configured to distribute the rewards to the customer for engaging with the plurality of business groups and collect details regarding the rewards collected by the customer from the respective business units or business entity.

The first CFL link 216 is a module capable of establishing communication with the concerned business units. The first CFL link 216 is initiated by the customer to interact with the concerned business units to provide an instant feedback, get assistance or fill out a survey. The concerned business units is enabled to respond to the customer over the first CFL link 216. The first CFL link 216 exists till either the customer or the business decides to terminate the CFL link. The CFL link is maintained even after the leaving of the customer from the premises of a business unit or business group.

The modules present at the application server 106 is configured to increase the computing and processing capability compared to the modules at the computing device 102. The user interface 218 is configured to allow the customer and the business groups to interact with the application server 106. The requests received by the customers is translated to a machine-understandable request. According to an embodiment herein, a plurality of standard techniques is utilized to generate machine-understandable requests.

The san module 220 is configured to process the linear codes decoded by the scan decoder 206. Thus, the scan module 220 is configured to identify the corresponding business objects having the decoded linear codes. Based on the business objects, the application server 106 chooses the concerned business units for engaging with the customer. The sensing module 222 processes the requests communicated by the sensing decoder 208 of the computing device. According to an embodiment herein, the sensing module 222 is configured to decode the business objects detected by the computing device. Further based on the business objects identified, the concerned business units are allowed to engage with the customers.

The geofence module 250 is further configured to process the location coordinates of the business objects tracked by the geofence decoder 248. Based on the location coordinates tracked, the customer interaction with the concerned business units in the geographical location is initiated. When the customer enters in the range of a business object defined by the location coordinates such as a store, room, airport, hospital, stadium and the like, the customer is prompted with queries to engage with the services of a particular business unit or a survey. Further, when the customers enters into a location such as a building having more than one business unit, then the concerned business units are identified by sensing the business objects in the premises using the sensing decoder 208.

Further, the message responder 224 is configured to create the reply messages for the customers and responds back to the messages communicated by the customers through the message manager 210. The message responder 224 is configured to respond to the messages either automatically or with the help of a human responder. The plurality of messages are generated artificially by bots using standard templates. Further, the plurality of messages are generated dynamically by manual intervention. The survey manager 226 is configured to create surveys and to monitor the surveys. Further, the responses shared by the customers are stored in the survey manager 226 for further analysis.

The rewards manager 228 is configured to manage the reward points of each customer. According to an embodiment herein, the reward points are added to the customers based on the engagement activities of the customers with the business groups. The rewards manager 228 is configured to enable the customer to redeem the reward points earned by actively engaging with the business groups.

The second CFL link 230 is provided to establish a continuous feedback loop with the first CFL link 216 of the computing device 102 for engaging with the customers. The CFL link 230 is terminated when the business groups or the customers initiate terminate of the session. The database 234 is a storage module for storing a plurality of data in the application server 106. The plurality of data includes but are not limited to the details of the customers, the details of the business groups, the details of the business objects, metadata of the application server 106 and the like.

The routing module 236 is configured to receive an engagement request from the customers and routes to the concerned business units accordingly. According to an embodiment herein, the routing module 236 is configured to determine or identify type of the request and route the request to the concerned or respective business units. The type of request from a customer includes rule based automatic alerts or queries sent by the customer. The routing module 236 is configured to identify automatic alerts based on certain or preset rules. Further, the routing module 236 is configured to route the request from the customer to the concerned or respective business units based on text analytics. Based on the text analytics, the routing module is configured to identify a positive feedback, negative feedback, seeking help from a particular business unit etc.

The profile and login manager 238 is configured to manage the profiles of both the customers and the business groups. The plurality of details of the customers and the business groups are stored securely in the profile and login manager 238. Further, the user role and profile manager 240 is configured to determine to identify the user roles and activities which are used for various purposes such as advertisements.

The object list 242 includes the plurality of business objects that are sensed by the sensing decoder 208, scan decoder 206 and geofence decoder 248. The object list 242 is dynamically updated and refreshed periodically for allowing the application server 106 to increase the number of business objects. The subscription and billing module 244 is configured to maintain and manage the subscription services availed by the business groups.

The notification module 246 is configured to notify the customers as well the business groups using a plurality of notification methods such as SMS, e-mail, VoIP, and the like. The report scheduler module 252 is configured to schedule the reports of the services availed by the customers for subscription and billing purposes. The helpdesk and CRM tunnel 256 is a computer implemented program that allows the customer engagement platform to communicate with existing IT infrastructure. The computer implemented program for helpdesk includes helpdesk ticketing systems like service desk, CRM software modules like Salesforce etc. The export module 254 is configured to allow the business units or entities to export the customer engagement data into other formats, so that the customer engagement data is consumed or used by their own third-party IT systems.

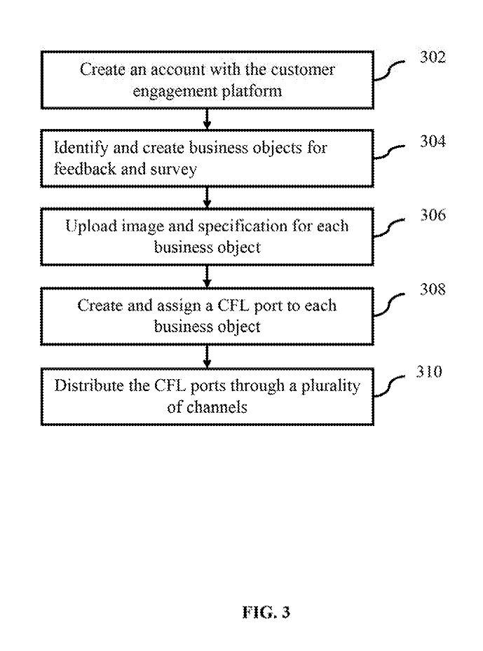

FIG. 3 illustrates a flowchart explaining a process of business engagement with a plurality of customers, according to one embodiment herein. Initially, an account is created by the business groups with the application server for actively engaging with a plurality of customers (Step 302). The account is created by providing details including login credentials, company name, and the like to the applications server. Once the account is created, the platform enables the business groups to identify and create business objects for feedback, and survey.

Further, the business application is run and executed to identify and creates business objects for feedback and survey (Step 304). The term “business objects” refers to one or more attributes for which the businesses engage with the plurality of customers. The examples of the plurality of business objects include, but are not limited to physical objects, locations, stakeholders, services, and the like. The business objects created are stored as object list in the application server. The object list is dynamically updated and refreshed periodically. According to an embodiment herein, the business objects are identified by using a plurality of sensors and other applications available in the computing device.

Further, one or more images and specification for each business object is uploaded to the application server for enabling the engagement with the customers (Step 306). The specifications includes unique identifiers for each business objects including but not limited to a linear code, location coordinates and the like. The images are analysed at the backend for understanding the nature of engagement and are processed accordingly.

Furthermore, a CFL link is established between the business units and the customers for active engagement. A CFL port is created and assigned to each business object (Step 308). According to an embodiment herein, a plurality of CFL links is established for a single object for providing active engagement at various levels. For example, when the customer raises a query for a product such as a laptop, the CFL port is established by the manufacturer, service provider, accessory manufacturer, and the like.

The established CFL ports are then distributed through a plurality of channels for engaging customers actively (Step 310). The engagement between the businesses and the customers are in a plurality of ways, including but are not limited to voice, SMS, e-mail, Messaging and the like.

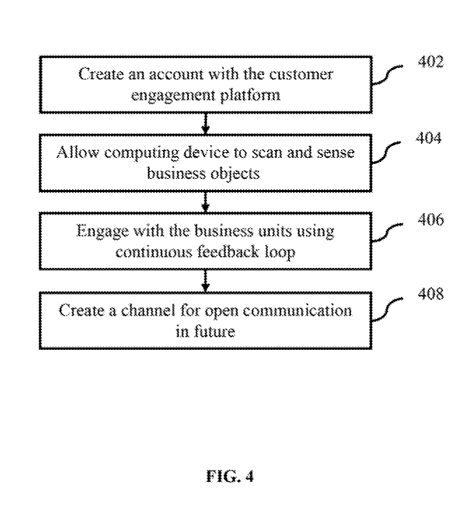

FIG. 4 illustrates a flowchart explaining a process of customer engagement with a plurality of businesses, according to an embodiment of the present invention. Initially, an account is created by the customers for engaging with the business units (Step 402). The customer creates the account by providing a plurality of details. The plurality of details provided by the customer includes, but not limited to name, e-mail id, contact details, phone number, location, and the like.

Once, the account is created, the computing device of the customer is allowed to sense or scan the business objects (Step 404). The business objects are sensed or scanned using the computational devices in a plurality of modes. A first mode includes capturing a plurality of images of business objects using a camera. The plurality of images are processed at the computational device or application server for identifying the business objects. A second mode includes scanning the business objects having a linear code using a code reader. The linear codes scanned are decoded in the computational device and transmitted to the application server for identifying the business objects.

A third mode includes sensing the business objects using a plurality of sensors. The plurality of sensors including Bluetooth, Global positioning systems (GPS), near field communication etc. The details of the business objects sensed are sent to the application server for identifying the business objects. A fourth mode includes and tracking the business units by identifying location coordinates along with event criteria including exit, entry and residence or stay period.

The sensed or scanned data is processed either locally or on the application server. Further, based on the sensed or scanned objects, concerned business units among the business groups are identified. On identifying concerned or respective business units, a continuous feedback loop is created and the customers are engaged actively with the concerned business units through a listening port (Step 406). According to an embodiment herein, the customers are engaged through the message, voice, interactive voice response, e-mail, chat, and the like. Once the engagement is completed, the business groups create a channel for open communication in the future (Step 408).

The embodiments herein provide a method and system for engaging a plurality of customers with a plurality of business units using a single platform. The embodiments discloses a system and method that initiates the process using a computing device such as a smartphone using a continuous feedback loop. The continuous feedback loop provides a continuous connection and conversation between the business units and the customer. Further, the system allows the businesses to connect to the customers from anywhere

Further, a universal detection technology that allows engaging customers through scanning barcodes, QR codes, boarding passes, and sensing technologies like Beacons, transmitters, RFID, and the like is also provided. Further, the system also provides an incentive mechanism for business groups to grant points (rewards points) to the customers for providing feedback. The customers have the advantage to accrue cumulative points across multiple business groups and cash in for unified rewards.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A computer-implemented method for engaging a plurality of customer with a plurality of business units in near-real time using a customer engagement platform, the computer-implemented method comprises steps of:
creating accounts for a plurality of business units with a customer engagement platform built on an application server for actively engaging with a plurality of customers;
creating a plurality of business objects using the customer engagement platform for receiving feedback from the plurality of customers, by creating and uploading images and specification of the plurality of business to the application server;
registering the plurality of customers with the customer engagement platform for engaging with the plurality of business units, wherein each customer is registered by providing a plurality of details through a computing device;
storing a plurality of data in a database in the application server, wherein the plurality of data includes, plurality of details of the customers, the account details of the plurality of business units, the business objects created, and metadata of the application server;
identifying business objects using the computing device when a customer enter a premises in a plurality of modes;
transmitting details of the identified business objects to the application server;
processing the details of the business objects identified for routing requests of the customer to concerned business units;
establishing a continuous feedback loop (CFL) link between the concerned business units and the customer for providing active near real time engagement, and wherein the customers are engaged by responding to queries and service request raised by the customers; and
terminating the CFL link based on a decision of the customer or the business unit.

2. The method as claimed in claim 1, wherein the step of engaging a plurality of customer with a plurality of business units in near-real time is performed by sending a plurality of messages through the CFL link established.

3. The method as claimed in claim 1, further comprises initiating a survey with the customer based on the business objects identified by the computing device.

4. The method as claimed in claim 1, wherein the plurality of modes for identifying the business objects when the customer enter the premises comprises:
capturing a plurality of images of a first business object using a camera in the computing device, and wherein the plurality of images are processed by the application server for identifying the first business object
scanning a linear code on a second business object using a code reader in the computing device, and wherein the linear code is decoded by one of the computing device and application server to identify the second business object;
sensing presence of a third business object using a plurality of sensors in the computational device, and wherein data sensed is analyzed by the application server to identify the third business object; and
tracking location coordinates of a fourth business object along with event criteria, exit time, entry time and stay period or residence time, and wherein the location coordinates are transmitted to the application server to identify the fourth business object.

5. The method as claimed in claim 1, wherein the plurality of details provided for registering with the application server includes name, e-mail id, contact details, phone number, and location.

6. The method as claimed in claim 1, wherein the plurality of business objects created includes physical objects, locations, stakeholders, and services.

7. The method as claimed in claim 1, wherein the plurality of business objects uploaded to the application server is dynamically updated and refreshed periodically.

8. The method as claimed in claim 1, wherein the plurality of sensors for sensing the business objects includes Bluetooth, beacon, near field communicators, radiofrequency (RF) transmitters, and geo-location services.

9. The method as claimed in claim 1, further includes establishing the CFL link through the application server, when the customer requires assistance or raises a service request.

10. The method as claimed in claim 1, further includes billing the subscription services availed by plurality of business units.

11. The method as claimed in claim 1, wherein the step of engaging a plurality of customer with a plurality of business units in near-real time is achieved through any one of surveys, enterprise feedback management, experience sharing, customer feedback, customer satisfaction, net promoter score, top box scores, voice of the customer, customer experience, instantaneous feedback, actionable feedback, customer service, help desk, and instantaneous response.

12. The method as claimed in claim 1, further comprises providing reward points to the plurality of customers based on engagement activities of each customer with a plurality of business groups.
